(19) United States
(12) Patent Application Publication
(10) Pub. No.: US 2024/0116478 A1
(43) Pub. Date: Apr. 11, 2024

(54) METHOD FOR SUPPORTING A CARRIER VEHICLE

(71) Applicant: Palfinger AG, Bergheim bei Salzburg (AT)

(72) Inventors: Benjamin Juds, Salzburg (AT); Werner Emminger, Lochen (AT); Friedrich Gschaider, Lamprechtshausen (AT); Boban Petronijevic, Hallwang (AT)

(21) Appl. No.: 18/392,726

(22) Filed: Dec. 21, 2023

Related U.S. Application Data
(63) Continuation of application No. PCT/AT2022/060212, filed on Jun. 23, 2022.

(30) Foreign Application Priority Data
Jun. 24, 2021 (AT) GM 50128/2021

(51) Int. Cl. B60S 9/02

(52) U.S. Cl. CPC B60S 9/02; B60P 1/5433

(57) ABSTRACT

A support system includes supporting legs, adjustable at least vertically in their longitudinal extent, to provide support on a substrate, a controller for controlling drives of the supporting legs using control commands, and an inclinometer for sensing an inclination of a carrier vehicle and/or of a lifting apparatus relative to at least one predetermined or predeterminable spatial direction and/or spatial plane. A method for supporting the carrier vehicle, parked on the substrate, for a lifting apparatus with a support system includes a calculation method step in which a sequence of control commands is calculated, and a levelling method step in which sequential and time-limited control of individual drives of the supporting legs takes place so as to minimize the inclination. The calculation method step and the levelling method step being repeated in a loop.

### BACKGROUND OF THE INVENTION

The present invention relates to a method for supporting a carrier vehicle, parked on a piece of ground, for a lifting device with a support system, a computer program product for executing such a method, a controller for a support system for carrying out such a method, and a vehicle with such a controller.

It is known in the state of the art that carrier vehicles are supported on a piece of ground with support systems, for example for increasing the stability of the carrier vehicle, or in order to orient the carrier vehicle relative to a predefined or predefinable spatial direction and/or spatial plane. The supporting is normally effected via supporting legs which are adjustable in terms of their longitudinal extent and which can be supported on the piece of ground and can influence the inclination of the carrier vehicle by alteration of the longitudinal extent. An inclination of the carrier vehicle and/or of the lifting device relative to a predefined or predefinable spatial direction and/or spatial plane can be detected with an inclination sensor.

Devices in the form of hydraulically operable support systems for leveling a carrier vehicle are known in the state of the art, in which the operation of the individual supporting legs is effected manually and iteratively until a predefined leveling of the carrier vehicle is achieved (usually between 0° and 3° with respect to the horizontal).

Devices and methods which make an at least partially automatically controlled leveling of a carrier vehicle possible are further known in the state of the art.

A leveling system with extendable supporting legs with hydraulic cylinders is known from the document U.S. Pat. No. 5,580,095 A. Operation times for the supporting legs, for the duration of which an activation of the supporting legs can be effected, can be calculated starting from a measured inclination about a transverse axis and about a longitudinal axis of a carrier vehicle.

A leveling mechanism with support cylinders which can be selectively supplied with hydraulic fluid is known from the document DE 40 33761 C1. For leveling a body to be leveled, the support cylinders can be extended synchronously or successively with metered quantities of hydraulic fluid.

### SUMMARY OF THE INVENTION

The object of the invention is to specify a method for leveling a carrier vehicle that is improved compared with the state of the art.

The object is achieved by a method as discussed below, a computer program product for executing such a method, and a controller which is formed for carrying out such a method.

The method serves for supporting a carrier vehicle with a support system on a piece of ground. Through a support system, for example, an increase in the stability of the carrier vehicle can be achieved and the carrier vehicle can be oriented relative to a predefined or predefinable spatial direction and/or spatial plane.

A predefined or predefinable spatial plane can be, for example, a horizontal plane. A possible orientation which can be achieved after minimization of the inclination of the carrier vehicle and/or the lifting device can be, for example, between 0° and 3° with respect to the horizontal.

The supporting is normally effected via supporting legs which are adjustable in terms of their longitudinal extent and which can be supported on the piece of ground and can influence the inclination of the carrier vehicle and/or the lifting device by alteration of the longitudinal extent.

There can be an inclination of the carrier vehicle and/or the lifting device due to parking on an inclined piece of ground. An inclination can also be caused by a payload of the carrier vehicle or a loading of a lifting device arranged on the carrier vehicle.

The support system can be connected to the vehicle frame. If the carrier vehicle has a lifting device, the support system can be connected to the lifting device.

The support system can have two or more supporting legs. The supporting legs can be arranged in different positions relative to the carrier vehicle or the lifting device.

In particular, the support system can have four supporting legs, which can be part of a so-called H support (H-shaped arrangement of the supporting legs) or an X support (X-shaped arrangement, also called star support).

The support system can have a controller for actuating drives of the supporting legs using control commands. For example, the supporting legs can have drives in the form of hydraulic cylinders for retracting and/or extending the supporting legs, and the controller can actuate magnetically operable control valves of the hydraulic cylinders using control pulses. A corresponding activation of electric drives is not to be ruled out.

It is not to be ruled out that the support system has horizontally adjustable supporting arms, on which the supporting legs are arranged. It is also not to be ruled out that the controller is formed for actuating drives of the supporting arms using control commands.

The support system can have at least one inclination sensor for detecting an inclination of the carrier vehicle and/or of the lifting device relative to at least one predefined or predefinable spatial direction and/or spatial plane.

For example, the inclination of the carrier vehicle and/or of the lifting device relative to two spatial directions can be detected.

In particular, inclinations relative to two spatial directions which span a horizontal plane can be detected.

For example, an inclination about a transverse axis and/or about a longitudinal axis of a carrier vehicle, for example with reference to a frame of the carrier vehicle, can be detected. The detected inclination can be with reference, for example, to a horizontal orientation of the carrier vehicle.

For example, an inclination of a lifting device arranged on a carrier vehicle, in particular a crane column of a lifting device, relative to at least one spatial direction in a horizontal and/or vertical plane can be detected.

A detected inclination can be, for example, an angle of a substantially vertically running swivel axis of a crane column of a lifting device relative to a horizontal plane, spatial plane or spatial direction. For the orientation, an at least approximately right angle of the swivel axis of the crane column relative to the horizontal can be sought.

In the method, in a calculation method step a sequence of control commands for the sequential and time-limited activation of individual drives of the supporting legs of the support system can be calculated on the basis of a currently detected inclination of the carrier vehicle and/or of the lifting device.

The calculation of the control commands can be effected with the aim of orienting the carrier vehicle relative to a predefined or predefinable spatial direction and/or spatial plane. In the case of such an orientation or leveling a spatial direction and/or spatial plane can be predefined or predefinable, and a part of the carrier vehicle or of a lifting device arranged on a carrier vehicle can be oriented relative to this spatial direction and/or spatial plane by executing the calculated control commands.

The calculation of the control commands can be effected such that a reduction of the inclination is achievable to a certain degree through the execution of the control commands.

It is not to be ruled out that an orientation relative to two different spatial directions can be effected when the method is carried out.

With a currently detected inclination of the carrier vehicle and/or of the lifting device, a deviation relative to the predefined or predefinable spatial direction and/or spatial plane can be determined, and corresponding control commands for reducing the deviation can be calculated.

By currently detected inclination of the carrier vehicle and/or of the lifting device can be meant the inclination of the carrier vehicle and/or of the lifting device prevailing immediately before or while the calculation method step is carried out.

In a leveling method step, in principle, an activation of the drives of the supporting legs of the support system can be effected for reducing the inclination of the carrier vehicle and/or of the lifting device. During execution of a leveling method step the inclination of the carrier vehicle and/or of the lifting device can be at least partially reduced.

During activation of the drives of the supporting legs of the support system using the sequence of control commands a sequential and time-limited activation of individual drives of the supporting legs of the support system can be effected using control pulses.

Individual drives of the supporting legs can be actuated substantially separately from each other in terms of time in an order or sequence.

The activation of the drives can be effected using control pulses which are output sequentially by the controller and time-limited.

An activation of a drive of a supporting leg can, in principle, be effected for the time duration of a control pulse.

In the method, a repetition of the calculation method step and of the leveling method step can be effected in a loop for minimizing the inclination of the carrier vehicle and/or of the lifting device.

The inclination of the carrier vehicle and/or of the lifting device relative to at least one predefined or predefinable spatial direction and/or spatial plane can be effected in each pass through the loop, during which a repetition of the calculation method step and of the leveling method step is effected, a partial reduction of the inclination relative to at least one predefined or predefinable spatial direction and/or spatial plane.

An inclination of the carrier vehicle and/or of the lifting device and a corresponding deviation from the desired orientation can be detected in each pass through the loop.

If the inclination of the carrier vehicle and/or of the lifting device is only partially reduced during an execution of an individual leveling method step, a further sequence of control commands for the sequential and time-limited activation of individual drives of the supporting legs of the support system can be calculated in at least one further calculation method step on the basis of an inclination of the carrier vehicle and/or of the lifting device detected after the preceding leveling method step has been carried out.

Subsequently, in at least one further leveling method step an activation of the drives of the supporting legs of the support system can be effected using the further sequence of control commands for minimizing the inclination of the carrier vehicle and/or of the lifting device relative to at least one predefined or predefinable spatial direction and/or spatial plane.

This repetition loop can be passed through until the detected inclination of the carrier vehicle and/or of the lifting device reaches or falls below a predefined or predefinable threshold value. The threshold value can be with reference to the inclination of the carrier vehicle and/or of the lifting device relative to at least one predefined or predefinable spatial direction and/or spatial plane.

Through the method, instead of a clocked activation, thus a temporally dimensioned, continuous and possibly simultaneous activation, of the supporting legs, an orientation of a carrier vehicle, parked on a piece of ground, for a lifting device with a support system can be broken down into a sequential sequence of a plurality of control pulses with, in each case, limited time duration.

Through the activation of the drives using control pulses which are sequentially output by the controller and time-limited, an inclination of the carrier vehicle and/or of the lifting device can be incrementally reduced.

In a calculation method step a sequence of control commands for the sequential and time-limited activation of individual drives of the supporting legs of the support system for the partial reduction of the inclination of a carrier vehicle and/or of the lifting device can generally be calculated. A partial reduction of the inclination can be a part of the total desired or required reduction of the inclination for orienting the carrier vehicle and/or the lifting device.

In a leveling method step a partial reduction of the inclination of a carrier vehicle and/or of the lifting device can generally be effected. A partial reduction of the inclination can be a part of the total desired or required reduction of the inclination for orienting the carrier vehicle and/or the lifting device.

A repetition of the calculation method step and of the leveling method step can be effected in a loop for minimizing the inclination of the carrier vehicle and/or of the lifting device, wherein during each repetition of the loop a sequence of control commands for the partial reduction of the inclination of a carrier vehicle and/or of a lifting device can be calculated and the sequence of control commands for the partial reduction of the inclination of a carrier vehicle and/or of the lifting device can be implemented. This can be effected incrementally until the detected inclination of the carrier vehicle and/or of the lifting device reaches or falls below a predefined or predefinable threshold value, thus in total the desired or required reduction of the inclination for orienting the carrier vehicle and/or the lifting device is achieved.

In an advantageous embodiment of the method, for example after the carrier vehicle has been parked on the piece of ground, an activation of the drives of the supporting legs of the support system can be effected in a floor-contact method step using control commands, through which the supporting legs are brought into contact with the piece of ground. The control commands can be calculated as a sequence of control commands for the sequential and time-limited activation of individual drives of the supporting legs of the support system on the basis of a currently detected inclination of the carrier vehicle and/or of the lifting device.

In an advantageous embodiment of the method, after minimization of the inclination of the carrier vehicle and/or of the lifting device has been effected, a continuous detection of an inclination of the carrier vehicle and/or of the lifting device relative to at least one predefined or predefinable spatial direction and/or spatial plane can be effected in a monitoring method step.

If, for example after supporting and orientation of the carrier vehicle, a lifting device arranged thereon is used during working operation, or for example a payload of the carrier vehicle is altered, undesired changes in the inclination of the carrier vehicle and/or of the lifting device can occur due to the loads occurring and/or alterations in the piece of ground used for the supporting. These can be recognized and determined through a continuous detection of the inclination.

When the detected inclination reaches or exceeds a predefined or predefinable deviation, a repetition of the execution of at least one calculation method step and of at least one leveling method step can be effected. The deviation can be with reference to the threshold value used for the orientation.

Such a repetition can be effected autonomously by the controller or after corresponding confirmation, or by targeted selection by a user.

Analogously to the minimization of the inclination of the carrier vehicle and/or of the lifting device, a repetition of the calculation method step and of the leveling method step can be effected in a loop until the detected inclination of the carrier vehicle and/or of the lifting device again reaches or falls below a predefined or predefinable threshold value.

In an advantageous embodiment of the method, in a calculation method step, which follows a leveling method step carried out beforehand, a change in the inclination due to the preceding leveling method step can be detected. It can be determined whether a corresponding reduction of the inclination was achieved with effected execution of the control commands. It can be deduced from this whether the actuated supporting legs have been in floor contact. It is not to be ruled out that a torsional and bending stiffness and/or a twisting of the carrier vehicle can be determined thereby.

In an advantageous embodiment of the method, the time-limited activation of the individual drives of the supporting legs of the support system using the sequence of control commands can be effected using control pulses with variable pulse duration. Different parameters of the support system can be taken into account with a variable pulse duration.

The pulse duration of the control pulses can advantageously be 0.05 seconds to 3.50 seconds. The pulse duration of the control pulses can preferably be 0.25 seconds to 1.5 seconds. It is conceivable that the pulse duration of the control pulses is 0.25 to 0.50.

A variation of the pulse duration—and where applicable of a duration of an overlap of successive control pulses—can in principle be effected depending on:
parameters of the drives of the supporting legs, such as for instance the lifting rate, the piston diameter or the pumping power and/or
parameters of the geometry of the supporting legs, such as for instance the prevailing or possible longitudinal extent, or a length of extension arms with supporting legs of the support system and/or
parameters of the position of the supporting legs and/or
the number of supporting legs and/or
the currently measured inclination of the carrier vehicle and/or of the lifting device, and/or
the currently predefined pulse duration, for example calculated in a preceding calculation method step, and/or
the number and/or position of axles of the carrier vehicle and/or
the position of a lifting device arranged on the carrier vehicle and/or
a torsional and bending stiffness and/or a twisting of the carrier vehicle
the predefined or predefinable spatial direction and/or spatial plane.

In an advantageous embodiment of the method, the activation of the drives of the individual supporting legs of the support system using the sequence of control commands can be effected in an activation sequence in a predefinable or predefined order. Particular supporting legs of the support system can preferably be actuated.

A preferred activation can be effected, for example, in order to keep a center of gravity of the carrier vehicle as low as possible or in order to take torsional and bending stiffnesses of the carrier vehicle into account.

A preferred activation can comprise a selection or weighting of individual or several supporting legs.

In an advantageous embodiment of the method, the longitudinal extent of the supporting legs can be made larger and/or smaller during an activation of the drives of the supporting legs of the support system in a leveling method step. The support system can thereby not only lift the carrier vehicle away from the piece of ground, but also lower it toward the piece of ground.

In an advantageous embodiment of the method, the activation of the individual drives of the supporting legs of the support system using the sequence of control commands can be effected using control pulses with a time-limited, predefined or predefinable overlap between successive control pulses. Control pulses succeeding one another in the sequence of control commands can be simultaneously output by the controller in sections.

An overlap of control pulses can be calculated in a calculation method step.

Thus, for example, the activation of a drive of one supporting leg for the duration of a control pulse can be started by output by the controller, and the activation of the drive of the next supporting leg according to the calculated sequence can already be started before the ongoing control pulse has ended.

The time-limited, predefined or predefinable duration of the overlap determines the duration of an activation, which is simultaneous in sections, of drives of supporting legs.

A substantially smooth orientation of a carrier vehicle can be effected through an overlap between successive control pulses. Vibrations occurring due to abrupt switching on and off of drives of supporting legs can be lessened.

Within the overlap between successive control pulses a simultaneous activation of at most two drives can advantageously be effected.

The duration of the overlap between successive control pulses output by the controller can generally be between 0.01 seconds and 0.5 seconds. The duration of the overlap can preferably be between 0.01 seconds and 0.1 seconds.

Protection is also sought for a computer program product comprising commands which, when executed by a computing unit, prompt the latter to execute a method as described previously from a storage unit which is in or can be brought into data connection with the computing unit.

Commands of the computer program product can be recorded, for example, in at least one storage unit of a controller and can be executed by at least one computing unit of a controller.

Protection is also sought for a controller for a support system which is formed for carrying out a method as described previously.

The controller can, in principle, have at least one computing unit and at least one storage unit. The computing unit can is in or be able to be brought into data connection with the storage unit.

In a calculation operating mode a sequence of control commands for the sequential and time-limited activation of individual drives of the supporting legs of the support system can be calculable by the controller on the basis of a currently detected inclination of the carrier vehicle and/or of the lifting device.

The calculation can be effected, for example, by a computing unit of the controller, and calculated control commands can be stored in a storage unit of the controller.

In an activation operating mode of the controller the drives of the supporting legs of the support system can be actuatable using the sequence of control commands for reducing the inclination of the carrier vehicle and/or of the lifting device relative to at least one predefined or predefinable spatial direction and/or spatial plane, wherein, using the sequence of control commands, a sequential and time-limited activation of individual drives of the supporting legs of the support system is effected using control pulses.

Control commands stored in a storage unit of the controller can be output by the controller in accordance with the sequence.

In a loop operating mode of the controller, for minimizing the inclination of the carrier vehicle and/or of the lifting device, the calculation of the sequence of control commands and the activation of the drives of the supporting legs of the support system using the sequence of control commands can is able to be carried out repeatedly in a loop until the detected inclination of the carrier vehicle and/or of the lifting device reaches or falls below a predefined or predefinable threshold value.

In each pass through the loop a calculation can be effected by a computing unit of the controller, calculated control commands can be stored in a storage unit of the controller, and control commands stored in a storage unit of the controller can be output by the controller in accordance with the sequence.

Protection is also sought for a vehicle, in particular a carrier vehicle with a lifting device, with a support system as described previously and a controller as described previously for the support system. The lifting device can generally be formed as a crane, in particular as an articulated arm crane.

### BRIEF DESCRIPTION OF THE DRAWINGS

Embodiments of the invention are discussed with reference to the figures, in which:

FIG. 1, schematically shows the procedure of an embodiment of the method,

FIG. 2, schematically shows the procedure of a further embodiment of the method,

FIG. 3 is a side view of an embodiment of a carrier vehicle parked on an inclined piece of ground,

FIG. 4 is a side view of an embodiment of a leveled carrier vehicle parked on an inclined piece of ground,

FIG. 5 is a top view of an embodiment of a carrier vehicle,

FIG. 6 is a schematic representation top view of an embodiment of a carrier vehicle,

FIG. 7 is a schematic representation of a lifting device with an embodiment of a support system,

FIG. 8 is a perspective view of an embodiment of a carrier vehicle,

FIGS. 9a to 9e are schematic representations of a leveling, and

FIGS. 10a and 10b, are each a schematic representation of two successive control pulses.

### DETAILED DESCRIPTION OF THE INVENTION

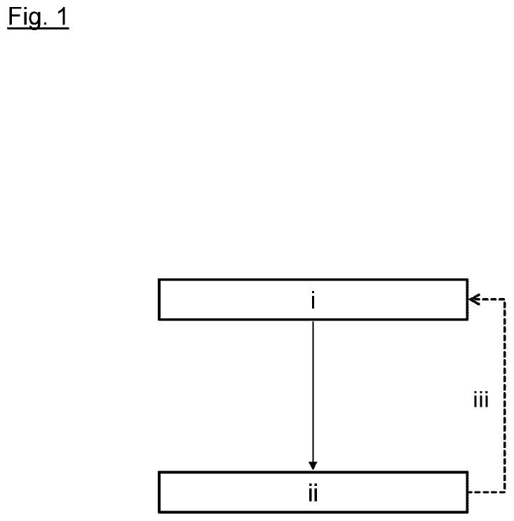

With reference to the embodiments, shown in the above figures, of a carrier vehicle 8 with a support system 7, FIG. 1 illustrates an embodiment of a method for supporting a carrier vehicle 8, parked on a piece of ground 10, for a lifting device 9 with a support system 7. The support system 7 comprises, as represented,
supporting legs 1, 2, 3, 4 vertically adjustable in terms of their longitudinal extent for supporting on the piece of ground 10, and
a controller 5 for actuating drives of the supporting legs 1, 2, 3, 4 using control commands, and
at least one inclination sensor 6 for detecting an inclination α of the carrier vehicle 8 and/or of the lifting device 9 relative to at least one predefined or predefinable spatial direction and/or spatial plane.

In a calculation method step i, a sequence of control commands for the sequential and time-limited activation of individual drives of the supporting legs 1, 2, 3, 4 of the support system 7 can be calculated on the basis of a currently detected inclination α of the carrier vehicle 8 and/or of the lifting device 9.

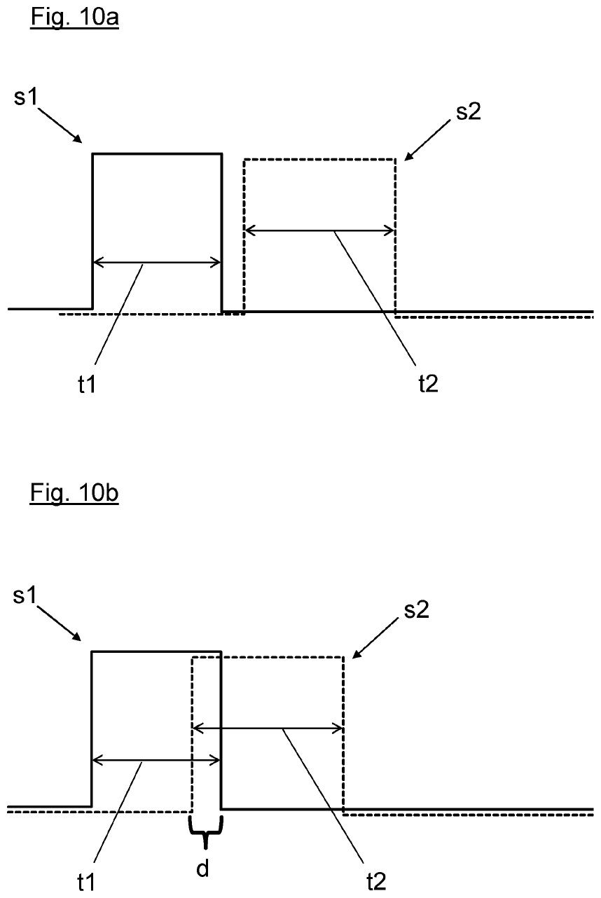

In a leveling method step ii following that, an activation of the drives of the supporting legs 1, 2, 3, 4 of the support system 7 can be effected using the sequence of control commands for reducing the inclination α of the carrier vehicle 8 and/or of the lifting device 9 relative to at least one predefined or predefinable spatial direction and/or spatial plane, wherein, using the sequence of control commands, a sequential and time-limited activation of individual drives of the supporting legs 1, 2, 3, 4 of the support system 7 can be effected using control pulses s1, s2 (see FIGS. 10a and 10b).

For minimizing the inclination α of the carrier vehicle 8 and/or of the lifting device 9, a repetition of the calculation method step i and of the leveling method step ii can be effected in a loop iii until the detected inclination α of the carrier vehicle 8 and/or of the lifting device 9 reaches or falls below a predefined or predefinable threshold value.

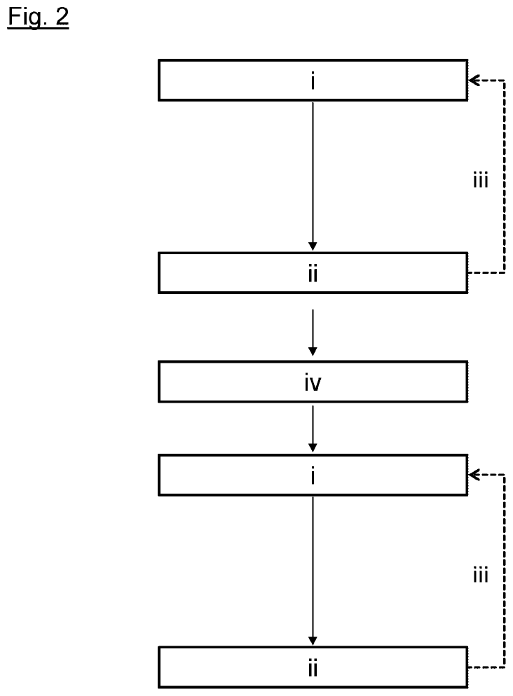

As in a particularly preferred embodiment of the method, as is shown schematically in FIG. 2, after minimization of the inclination α of the carrier vehicle 8 and/or of the lifting device 9 (steps i to iii) has been effected, a continuous detection of an inclination α of the carrier vehicle 8 and/or of the lifting device 9 relative to at least one predefined or predefinable spatial direction and/or spatial plane can be effected in a monitoring method step iv.

When the detected inclination α reaches or exceeds a predefined or predefinable threshold value, a repetition of the execution of at least one calculation method step i and of at least one leveling method step ii can be effected.

For minimizing the inclination α of the carrier vehicle 8 and/or of the lifting device 9 occurring, a repetition of the calculation method step i and of the leveling method step ii can be effected again in a loop iii until the detected inclination α of the carrier vehicle 8 and/or of the lifting device 9 again reaches or falls below a predefined or predefinable threshold value.

Generally, in the loop iii, in a calculation method step I, which can follow a leveling method step ii carried out beforehand, a detection of the change in the inclination α due to the preceding leveling method step ii can be effected. Effects of the activation carried out can thereby be assessed.

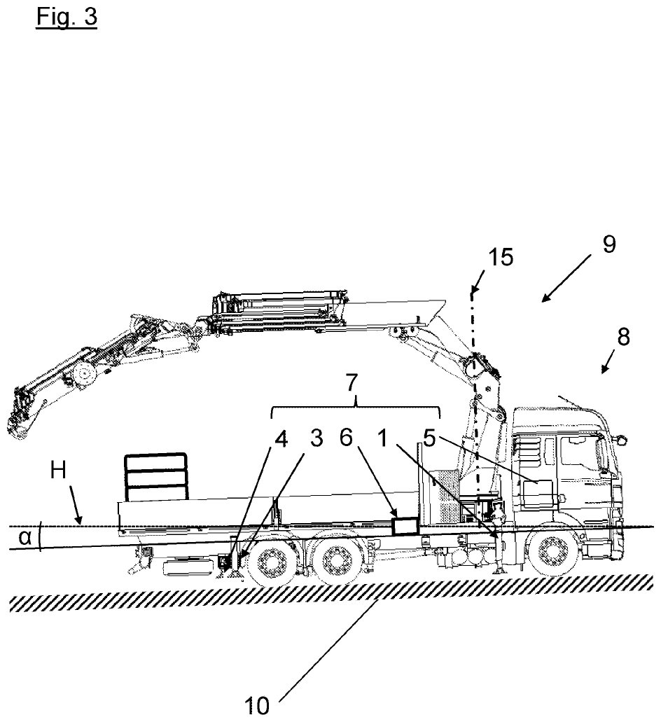

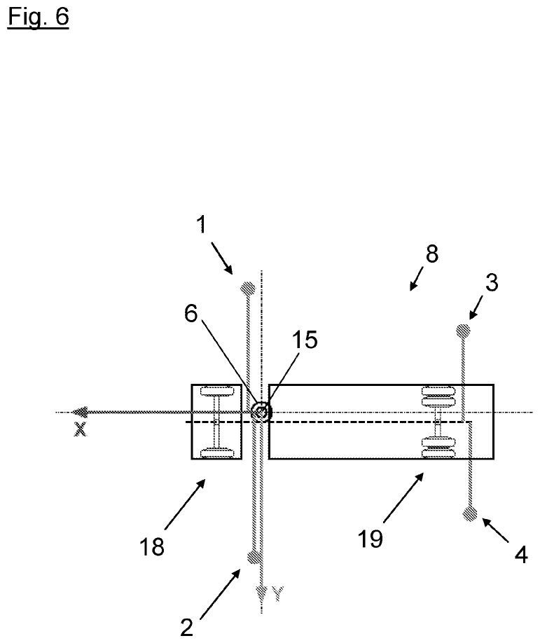

FIG. 3 shows a side view of an embodiment of a carrier vehicle 8 parked on an inclined piece of ground 10 (inclination angle in the representation is approximately 5°) with a lifting device 9 in the form of an articulated arm crane arranged thereon. The piece of ground 10 is inclined by an angle with respect to the horizontal H. In this unsupported state the carrier vehicle 8 parked on the inclined piece of ground 10 is inclined with respect to the horizontal H substantially about a transverse axis y of the carrier vehicle 8 (see FIG. 6) by the inclination α, in this embodiment measured relative to the vehicle frame. An inclination of the carrier vehicle 8 about a longitudinal axis x can analogously be there, but is not shown in this example embodiment.

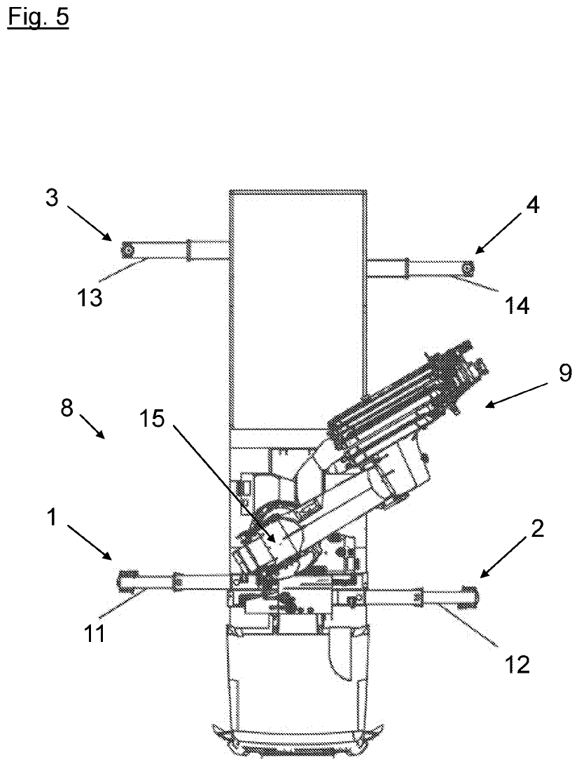

In this embodiment, the carrier vehicle 8 has a support system with four supporting legs 1, 2, 3, 4 (partially concealed, cf. also FIG. 5), an inclination sensor 6 and a controller 5, arranged on the carrier vehicle in this embodiment, for actuating drives of the supporting legs 1, 2, 3, 4 using control commands.

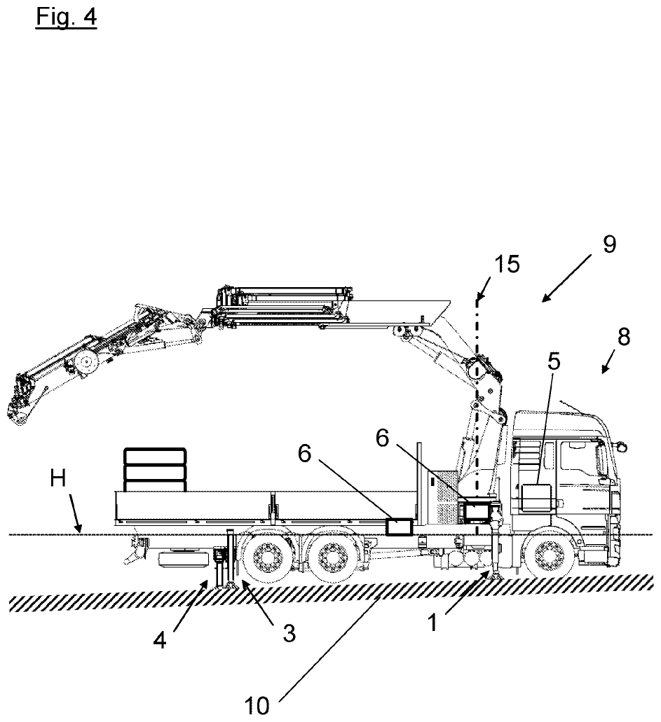

FIG. 4 shows a side view of the embodiment shown in FIG. 3 of a carrier vehicle 8 parked on an inclined piece of ground 10. The parked carrier vehicle has been oriented relative to the horizontal H and thus leveled after supporting has been effected via the supporting legs 1, 2, 3, 4 on the piece of ground 10 by carrying out the method. The inclination α with respect to the horizontal H is substantially 0° in the representation.

It can be seen that at least one wheel of the carrier vehicle 8 has remained on the piece of ground 10, thus the carrier vehicle 8 has not been completely lifted by the supporting legs 1, 2, 3, 4. Unlike what is represented, a complete lifting of the carrier vehicle 8 can also be effected.

Unlike what is represented, the inclination can also be with reference to the angle of a substantially vertically running swivel axis 15 of a crane column of the lifting device 9 relative to the horizontal H or to a vertical plane. For this, FIG. 4 shows an alternative or additional arrangement of the inclination sensor 6. For the orientation, an at least approximately right angle of the swivel axis 15 of the crane column relative to the horizontal can be sought.

Generally, an orientation relative to a predefined or predefinable spatial direction and/or spatial plane can be possible.

FIG. 5 shows a top view of an embodiment as shown previously of a carrier vehicle 8. As represented, the support system 7 has horizontally adjustable supporting arms 11, 12, 13, 14, on which the supporting legs 1, 2, 3, 4 are arranged. The controller 5 can be formed for actuating drives of the supporting arms 11, 12, 13, 14 using control commands.

FIG. 6, which shows a schematic representation of a top view of an embodiment of a carrier vehicle 8 with a front axle 18 and a rear axle 19 analogous to the preceding embodiments, illustrates the longitudinal axis x and the transverse axis y of the carrier vehicle 8. The inclination sensor 6 can, as represented, lie at the origin of the coordinate system spanned by the longitudinal axis x and the transverse axis y and situated on the swivel axis 15 of the crane column of the lifting device 9.

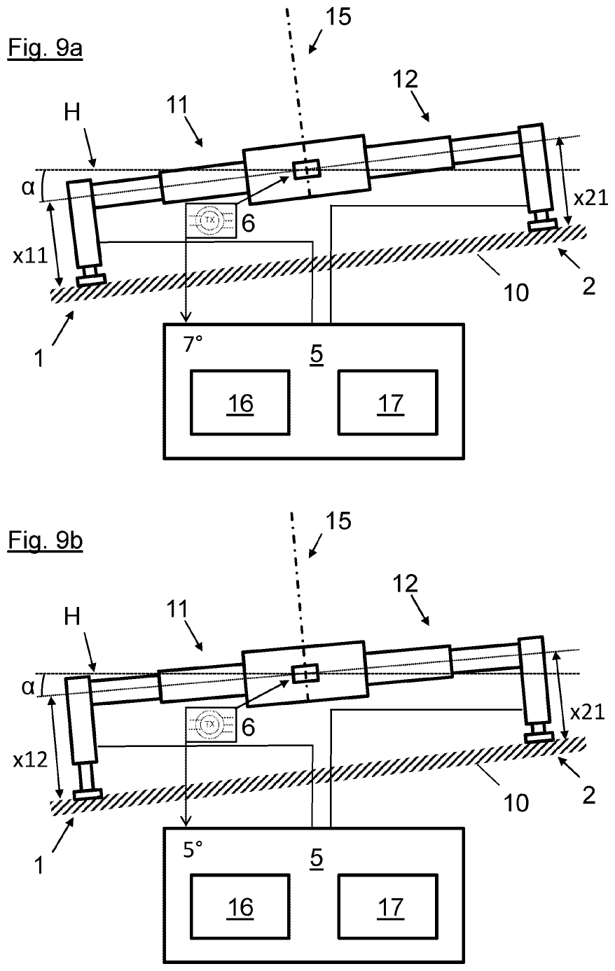

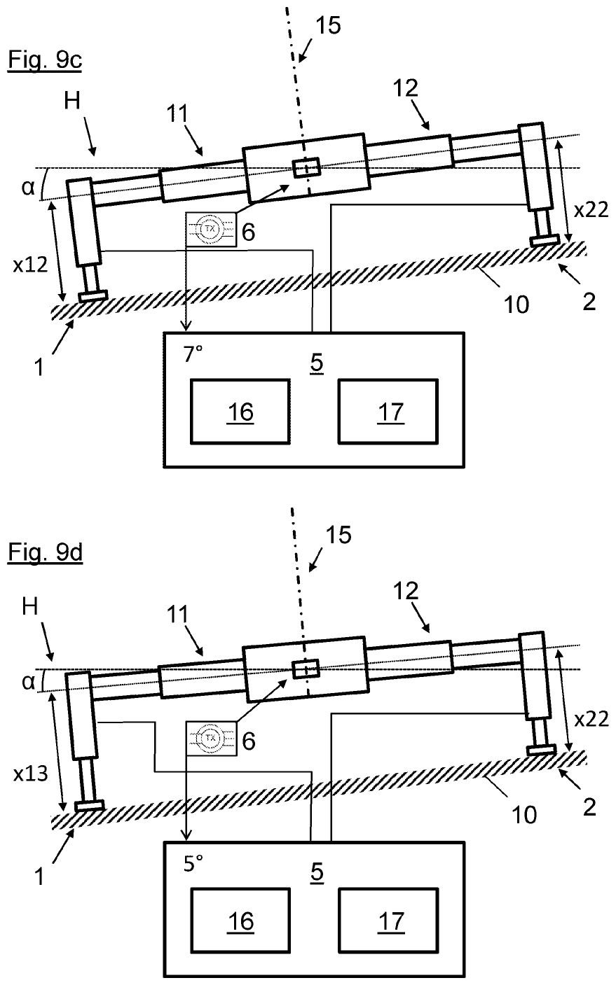

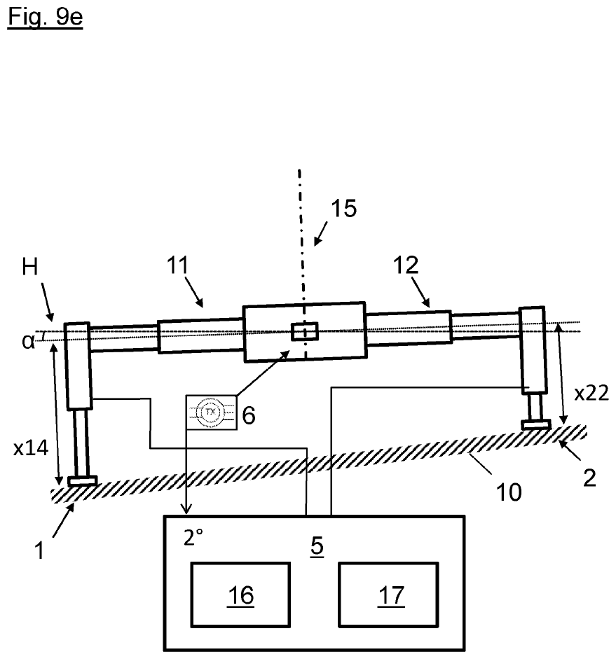

An orientation about the longitudinal axis x can be effected through the relationship of the longitudinal extents of the supporting legs 1 and 2 (cf. FIG. 9). An orientation about the transverse axis y can be effected through the constant component, thus the respective absolute value of the longitudinal extents.

A variation of the pulse duration t1, t2 of the control pulses s1, s2, using which the controller 5 (cf. FIG. 7) can actuate the drives of the supporting legs 1, 2, 3, 4, and possibly of an overlap d can be effected depending on:
parameters of the drives of the supporting legs 1, 2, 3, 4 and/or
parameters of the geometry of the supporting legs 1, 2, 3, 4, for instance the distance thereof from the swivel axis 15 of the crane column of the lifting device 8 and/or
parameters of the position of the supporting legs (1, 2, 3, 4), for instance the arrangement thereof on the vehicle frame relative to a lifting device 8, in particular relative to a swivel axis 15 of a crane column of the lifting device 8, and/or
the number of supporting legs 1, 2, 3, 4 and/or
the currently measured inclination α of the carrier vehicle 8 and/or of the lifting device 9 and/or
the currently predefined pulse duration t1, t2 and/or
the position of axles 18, 19 of the carrier vehicle 8 and/or
the position of a lifting device 9 arranged on the carrier vehicle 8 and/or
a torsional and bending stiffness and/or a twisting of the carrier vehicle 8 and/or
the predefined or predefinable spatial direction and/or spatial plane.

FIG. 7 shows a schematic representation of a lifting device 9 with an embodiment of a support system 7. The support system 7 comprises, as represented,
two supporting legs 1, 2, vertically adjustable in terms of their longitudinal extent, for supporting on a piece of ground 10, and
a controller 5 for actuating drives of the supporting legs 1, 2 using control commands, and
at least one inclination sensor 6 for detecting an inclination α of the lifting device 9 relative to at least one predefined or predefinable spatial direction and/or spatial plane.

Unlike what is represented, the support system 7 can have additional supporting legs and several inclination sensors 6, for instance such as those in FIGS. 3 to 6.

Besides the inclination sensor 6, the controller 5 can generally also be able to be supplied with measured values relating to operating parameters of the supporting legs 1, 2.

The controller 5 can, in principle, have at least one computing unit 16 and at least one storage unit 17. The computing unit 16 can is in or be able to be brought into data connection with the storage unit 17.

In a calculation operating mode a sequence of control commands in the form of control pulses for the sequential and time-limited activation of individual drives of the supporting legs 1, 2 of the support system 7 can be calculable by the controller 5 on the basis of a currently detected inclination α of the lifting device 9.

The calculation can be effected, for example, by a computing unit 16 of the controller 5, and calculated control commands can be stored in a storage unit 17 of the controller 5.

In an activation operating mode of the controller 5 the drives of the supporting legs 1, 2 of the support system 7 can be actuatable using the sequence of control commands for reducing the inclination α of the lifting device 9 relative to at least one predefined or predefinable spatial direction and/or spatial plane, wherein, using the sequence of control commands, a sequential and time-limited activation of individual drives of the supporting legs 1, 2 of the support system 7 can be effected using control pulses.

Control commands stored in a storage unit 17 of the controller 5 can be output by the controller 5 in accordance with the sequence.

In a loop operating mode of the controller 5, for minimizing the inclination α of the lifting device 9, the calculation of the sequence of control commands and the activation of the drives of the supporting legs 1, 2 of the support system 7 using the sequence of control commands can is able to be carried out repeatedly in a loop until the detected inclination α of the lifting device 9 reaches or falls below a predefined or predefinable threshold value.

In each pass through the loop a calculation can be effected by a computing unit 16 of the controller 5, calculated control commands can be stored in a storage unit 17 of the controller 5, and control commands stored in a storage unit 17 of the controller 5 can be output by the controller 5 in accordance with the sequence.

The longitudinal extent of the supporting legs 1, 2 can generally be made larger and/or smaller during an activation of the drives of the supporting legs 1, 2 of the support system 7.

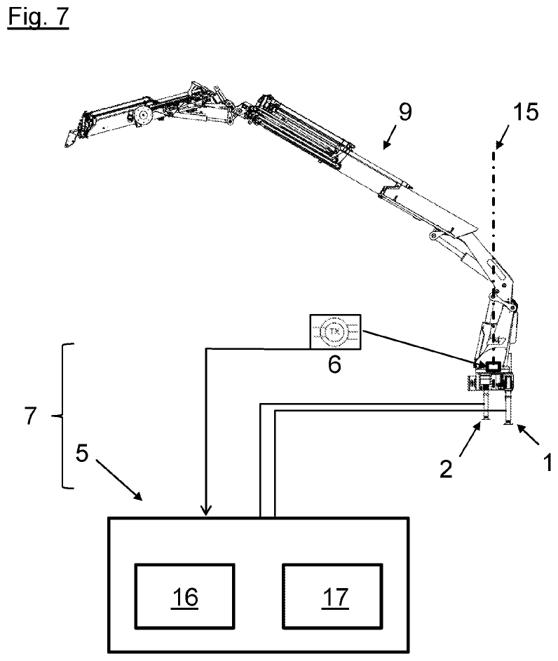

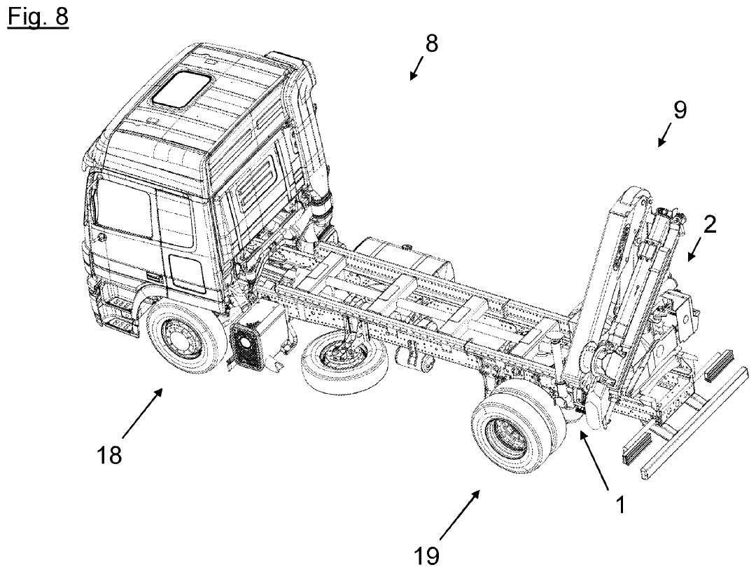

FIG. 8 shows a support device 7 analogous to the embodiment of FIG. 7 and arranged on a carrier vehicle 8 with lifting device 9.

An orientation, using a support system 7 (cf. FIG. 3 or FIG. 7), relative to a spatial direction H (horizontal) predefined by way of example is shown schematically in FIGS. 9a to 9d. The support system can be connected to a carrier vehicle, not represented in this figure, and/or a lifting device (swivel axis 15).

The orientation represented in FIGS. 9a to 9e can correspond, with reference to FIG. 6, to a leveling about a longitudinal axis x and also to a leveling about a transverse axis y.

The support system 7 has two supporting legs 1, 2 arranged on length-adjustable supporting arms 11, 12. The supporting legs 1, 2 are length-adjustable in terms of their longitudinal extent. The supporting legs 1, 2 used for the orientation in this sequence of figures have, as represented, different (settable) longitudinal extents x11, x12, x13, x14, x21, x22.

It is not to be ruled out that, unlike what is represented, the support system 7 has several supporting legs (for example four) and that several of these supporting legs are also used for the orientation, in particular relative to a spatial plane. However, for presentation reasons, the procedure is restricted to two supporting legs.

FIG. 9a shows a support system 7 supported on an inclined piece of ground 10, wherein the supporting legs 1, 2 have been brought into contact with the piece of ground. The direction of view can correspond to a view along a longitudinal axis of a carrier vehicle. The supporting legs 1, 2 in each case have a first longitudinal extent x11, x21. The inclination meter 6 outputs an inclination angle α of 7° measured with respect to the horizontal H.

Through the activation of the drives of the supporting legs 1 using control pulses s1, s2 which are sequentially output by the controller 5 and time-limited (see FIGS. 10a and 10b), an inclination α of a carrier vehicle and/or of a lifting device can be incrementally reduced.

In a calculation method step i (see FIG. 1), starting from the respectively measured inclination α, a sequence of control commands for the sequential and time-limited activation of individual drives of the supporting legs 1, 2 of the support system 7 for the partial reduction of the inclination α can be calculated. A partial reduction of the inclination, such as is represented by way of example from one figure of FIGS. 9a to 9e to another, can be a part of the total desired or required reduction of the inclination α for orienting the carrier vehicle or the lifting device.

A partial reduction of the inclination α can generally be effected in a leveling method step ii (see FIG. 1). A partial reduction of the inclination α can be a part of the total desired or required reduction of the inclination for orienting the carrier vehicle or the lifting device.

In FIG. 9b the supporting leg 1 has a second, larger longitudinal extent x12 after activation by the controller 5 using a control pulse s1. The inclination meter 6 outputs an inclination angle α of 5° measured with respect to the horizontal H, thus the inclination α has been partially reduced.

This can correspond, for example, to a first pass through the calculation method step i and the leveling method step ii.

A repetition of the calculation method step i and of the leveling method step ii can be effected in loops iii (see FIG. 1), wherein in each case control commands—and thus control pulses and possibly overlaps—for the supporting legs 1, 2 can calculated and activations of their drives can be effected using control pulses.

In FIG. 9c the supporting leg 2 has a second, larger longitudinal extent x22 after a pass through the loop iii and activation effected in the process by the controller 5 using a control pulse s2. The inclination meter 6 again outputs an inclination angle α of 7° measured with respect to the horizontal H. Although the inclination α has been made larger again relative to the shown spatial direction H, with reference to FIG. 6 an orientation about the longitudinal axis x can also be effected by changing the longitudinal extents of the supporting legs 1 and 2. Through the constant component, thus the respective absolute value of the longitudinal extents of the supporting legs 1, 2, an orientation about the transverse axis y can be effected. With reference to a horizontal spatial plane, the inclination relative to a spatial direction situated therein (for example seen orthogonal to the spatial direction H) can thus have been reduced again.

In further passes through the loop iii (see FIG. 1), in each case, a further repetition of the calculation method step i and of the leveling method step ii can be effected for minimizing the inclination α, wherein, during each repetition of the loop iii, a sequence of control commands and corresponding control pulses, and possibly overlaps of control pulses, for the partial reduction of the inclination α can be calculated and the sequence of control commands for the partial reduction of the inclination α can be implemented.

In FIG. 9d the longitudinal extent x13 of the supporting leg 1 has been made incrementally larger in a further pass through the loop iii.

In FIG. 9e the longitudinal extent x14 of the supporting leg 1 has been further made incrementally larger a further pass through the loop iii.

The sequence of FIGS. 9c to 9e represents, for example, three such repetitions of the loop iii, during which the longitudinal extent of the supporting legs 1, 2 is altered stepwise. The reduction of the inclination α is effected incrementally until the detected inclination α reaches or falls below a predefined or predefinable threshold value, which in the case shown is predefined by way of example as 2° with respect to the spatial direction H. It is not to be ruled out that an orientation relative to two different spatial directions can be effected when the method is carried out. Unlike what is represented, it is possible for a time-limited simultaneous sequential activation of the drives of the supporting legs 1, 2 (and possibly further supporting legs) to be effected for a predefined or predefinable duration.

FIGS. 10a and 10b in each case show a schematic representation of two successive control pulses s1, s2 with pulse duration t1, t2, wherein the sequential control pulses s1, s2 in FIG. 10b have a temporal overlap d.

Through an activation, as illustrated for example in FIGS. 9a, 9b and 9c, of the drives of the supporting legs 1 using control pulses s1, s2 which are sequentially output by the controller 5 and time-limited, an inclination α of a carrier vehicle 8 and/or of a lifting device can be incrementally changed.

In FIG. 9b the supporting leg 1 has larger longitudinal extent x12 compared with the representation in FIG. 9a after activation by the controller 5 using a first control pulse s1 with pulse duration t1. In FIG. 9c the supporting leg 2 has a larger longitudinal extent x22 compared with the representation in FIG. 9b after activation by the controller 5 using a second control pulse s2 with pulse duration t2. The activation can be effected, for example, using control pulses s1, s2 according to FIG. 10a.

Control pulses s1, s2 succeeding one another in the sequence of control commands can also be simultaneously output by the controller in sections, thus for the duration of an overlap d.

Thus, for example, according to FIG. 10b, the activation of a drive for example of the supporting leg 1 for the pulse duration t1 of the control pulse s1 can be started first. Before the ongoing control pulse s1 ends, the activation of the drive of the next supporting leg 2 can already be started with the output of the control pulse s2 sequentially following according to the calculated sequence.

The time-limited, predefined or predefinable duration of the overlap d can determine the duration of an activation, simultaneous in sections, of drives of supporting legs 1, 2.

### LIST OF REFERENCE NUMBERS

1 supporting leg
2 supporting leg
3 supporting leg
4 supporting leg
5 controller
6 inclination sensor
7 support system
8 carrier vehicle
9 lifting device
10 piece of ground
11 supporting arm
12 supporting arm
13 supporting arm
14 supporting arm
15 crane column swivel axis
16 computing unit
17 storage unit
18 carrier vehicle front axle
19 carrier vehicle rear axle
α inclination
i calculation method step
ii leveling method step
iii repetition loop
iv monitoring method step
H horizontal
x longitudinal axis
y transverse axis
x11, x12, x13, x14, x21, x22 supporting legs longitudinal extent
s1, s2 control pulse
t1, t2 pulse duration
d overlap

1. A method for supporting a carrier vehicle, parked on a piece of ground, for a lifting device with a support system, wherein the support system includes:
supporting legs, vertically adjustable in terms of their longitudinal extent, for supporting on the piece of ground, and
a controller for actuating drives of the supporting legs using control commands, and
at least one inclination sensor for detecting an inclination of the carrier vehicle and/or of the lifting device relative to at least one predefined or predefinable spatial direction and/or spatial plane,
wherein the method comprises:
a calculation method step in which a sequence of control commands for the sequential and time-limited activation of individual drives of the supporting legs of the support system is calculated on the basis of a currently detected inclination of the carrier vehicle and/or of the lifting device
a leveling method step in which an activation of the drives of the supporting legs of the support system using the sequence of control commands is effected for reducing the inclination of the carrier vehicle and/or of the lifting device relative to at least one predefined or predefinable spatial direction and/or spatial plane, wherein, using the sequence of control commands, a sequential and time-limited activation of individual drives of the supporting legs of the support system is effected using control pulses,
for minimizing the inclination of the carrier vehicle and/or of the lifting device, a repetition of the calculation method step and of the leveling method step is effected in a loop until the detected inclination of the carrier vehicle and/or of the lifting device reaches or falls below a predefined or predefinable threshold value.

2. The method according to claim 1, wherein, after minimization of the inclination of the carrier vehicle and/or of the lifting device has been effected, a continuous detection of an inclination of the carrier vehicle and/or of the lifting device relative to at least one predefined or predefinable spatial direction and/or spatial plane is effected in a monitoring method step.

3. The method according to claim 2, wherein, when the detected inclination reaches or exceeds a predefined or predefinable deviation, a repetition of the execution of at least one calculation method step and of at least one leveling method step is effected.

4. The method according to claim 3, wherein, in the loop, in a calculation method step, which follows a leveling method step carried out beforehand, a detection of the change in the inclination due to the preceding leveling method step is effected.

5. The method according to claim 1, wherein the time-limited activation of the individual drives of the supporting legs of the support system using the sequence of control commands is effected using control pulses with variable pulse duration.

6. The method according to claim 5, wherein the pulse duration of the control pulses is 0.05 seconds to 3.50 seconds, preferably 0.25 seconds to 1.5 seconds.

7. The method according to claim 5, wherein a variation of the pulse duration—and where applicable a temporal overlap between successive control pulses—is effected depending on:
parameters of the drives of the supporting legs and/or
parameters of the geometry of the supporting legs and/or
parameters of the position of the supporting legs and/or
the number of supporting legs and/or
the currently measured inclination of the carrier vehicle and/or of the lifting device, and/or
the currently predefined pulse duration and/or
the position of axles of the carrier vehicle and/or
the position of a lifting device arranged on the carrier vehicle and/or
a torsional and bending stiffness and/or a twisting of the carrier vehicle and/or
the predefined or predefinable spatial direction and/or spatial plane.

8. The method according to claim 1, wherein the activation of the drives of the individual supporting legs of the support system using the sequence of control commands is effected in an activation sequence in a predefinable or predefined order.

9. The method according to claim 1, wherein the longitudinal extent of the supporting legs is made larger and/or smaller during an activation of the drives of the supporting legs of the support system in a leveling method step.

10. The method according to claim 1, wherein the activation of the individual drives of the supporting legs of the support system using the sequence of control commands is effected using control pulses with a time-limited, predefined or predefinable overlap between successive control pulses.

11. The method according to claim 10, wherein a simultaneous activation of at most two drives is effected within the overlap between successive control pulses.

12. The method according to claim 10, wherein the duration of the overlap between successive control pulses is between 0.01 seconds and 0.5 seconds, preferably between 0.01 seconds and 0.1 seconds.

13. A computer program product comprising commands which, when executed by a computing unit, prompt the latter to execute the method according to claim 1 from a storage unit which is in or can be brought into data connection with the computing unit.

14. A controller for a support system which is formed for carrying out the method according to claim 1, wherein by the controller
in a calculation operating mode a sequence of control commands for the sequential and time-limited activation of individual drives of the supporting legs of the support system is calculable on the basis of a currently detected inclination of the carrier vehicle and/or of the lifting device, and
in an activation operating mode the drives of the supporting legs of the support system are actuatable using the sequence of control commands for reducing the inclination of the carrier vehicle and/or of the lifting device relative to at least one predefined or predefinable spatial direction and/or spatial plane, wherein, using the sequence of control commands, a sequential and time-limited activation of individual drives of the supporting legs of the support system is effected using control pulses, and
in a loop operating mode, for minimizing the inclination of the carrier vehicle and/or of the lifting device, the calculation of the sequence of control commands and the activation of the drives of the supporting legs of the support system using the sequence of control commands can be carried out repeatedly in a loop until the detected inclination of the carrier vehicle and/or of the lifting device reaches or falls below a predefined or predefinable threshold value.

15. A vehicle, in particular carrier vehicle with a lifting device, comprising the controller according to claim 14.
